(19) United States
(12) Patent Application Publication
(10) Pub. No.: US 2010/0281757 A1
(43) Pub. Date: Nov. 11, 2010

(54) TWO PART SLIP BOBBER AND METHOD OF ASSEMBLY

(76) Inventor: Gary Bennis, Eau Claire, WI (US)

Correspondence Address: WILLIAM D. HARE, 66 WITHERSPOON STREET, STE. 1, PMB 317, PRINCETON, NJ, 08542-9944, US

(21) Appl. No.: 12/774,710

(22) Filed: May 5, 2010

Related U.S. Application Data
(60) Provisional application No. 61/175,653, filed on May 5, 2009.

(51) Int. Cl. A01K 93/00

(52) U.S. Cl. 43/44.9; 43/44.94

(57) ABSTRACT

The invention is directed to a fishing bobber includes an upper float portion and a lower float portion. The upper float portion includes an outer surface terminating at one end in a first opening of a first diameter and terminating at a second end in a second opening of a second, larger diameter and having a tube extending from the first opening in the direction of the second opening. The lower float portion includes an outer surface terminating at one end in a first opening of a first diameter and terminating at a second end in a second opening of a second, larger diameter and having a tube extending from the first opening in the direction of the second opening. Mating the second opening of the upper float portion to the second opening of the lower float portion causes the tube of the upper float portion to mate with the tube of the lower float portion to form a channel passing through the combined first and second portions and a joint formed between the upper float portion and the lower float portion and between the tubes results in a cavity. The bobber may be formed using ultrasonic welding.

### RELATED APPLICATIONS

This invention is a utility application claiming priority to U.S. Provisional Patent Application No. 61/175,653, the contents of which are incorporated herein in their entirety by reference.

### FIELD OF THE INVENTION

This invention relates generally to a robust and durable slip bobber that is configured to be easily assembled.

### BACKGROUND OF THE INVENTION

The concept of fishing tackle such as fishing bobbers that can be used either as a slip bobber or a fixed line bobber is known in the art. Typically, in the slip bobber mode the fishing line extends freely through a tube in the fishing float. A string stop in the form of a knot is tied onto the fishing line. Usually a bead, which can slide along the fishing line, is placed on the fishing line with the knot forming a stop for the bead and the bead having a larger outside diameter than the tube to form a stop for the fishing bobber. The knot being small can pass through the eyes of the fishing rod and the fishing reel to allow the line with the knot to be wound up on the fishing reel. As one casts the line with the slip bobber and the bead the hook with the bait sinks allowing the fishing line to slide through the slip bobber until the bead engages the knot, which prevents further sliding of the bead along the fishing line. In addition, since the bead cannot pass through the tube in the fishing float it also stops the fishing float from sliding past the knot thus limiting the depth of the hook.

U.S. Pat. No. 6,158,164 to Mack et al. discloses a fixed fishing bobber that is formed by mounting a top half of a bobber to a lower half of a bobber. The bottom half of the bobber includes an attachment devices, such as a J-hook for mounting the fishing line to the bobber. The interior of the bobber includes metal weights. The '164 patent does not disclose the bobber configured for use as a slip bobber in which the fishing line passes through the length of the bobber.

U.S. Pat. No. 4,893,433 to Scheffler et al. discloses a two part slip bobber that mate together to form a buoyant body in which one of the halves includes a groove on the mating surface to form a channel for slidable reception of a fishing line. As disclosed in the '433 patent, the groove passes across the surface of the first half and through a threaded post extending from the first half to be received by the second, opposite half when the two halves are mated. The channel is formed by the groove in the first half and the wall of the second half upon mating the second half to the first half.

U.S. Pat. No. 4,616,441 to Dmytriw discloses bobbers made from two body members that are pressed together to form a watertight seal and in so doing secure the fishing line to the bobber. Other patents disclosing bobbers made from two body members include U.S. Pat. No. 4,563,831 to Gibney, U.S. Pat. No. 3,241,262 to Beverly, and U.S. Pat. No. 2,881,552 to Miller.

### SUMMARY OF THE INVENTION

In one general aspect there is provided a fishing bobber that includes an upper float portion and a lower float portion. The upper float portion includes an outer surface terminating at one end in a first opening of a first diameter and terminating at a second end in a second opening of a second, larger diameter and having a tube extending from the first opening in the direction of the second opening. The lower float portion includes an outer surface terminating at one end in a first opening of a first diameter and terminating at a second end in a second opening of a second, larger diameter and having a tube extending from the first opening in the direction of the second opening. Mating the second opening of the upper float portion to the second opening of the lower float portion causes the tube of the upper float portion to mate with the tube of the lower float portion to form a channel passing through the combined first and second portions and a joint formed between the upper float portion and the lower float portion and between the tubes results in a cavity.

Embodiments of the fishing bobber may include one or more of the following features. For example, the upper float portion may include a stem extending from the outer surface and terminating in the first opening in a direction that is generally opposite to the direction of the orientation of the tube in the upper float portion. The stem may include a tube attached to the upper float portion.

The lower float portion may include a stem extending from the outer surface and terminating in the first opening in a direction that is generally opposite to the direction of the orientation of the tube in the lower float portion. The fishing bobber further includes a ring positioned between the upper float portion and the lower float portion.

The tube in the upper float portion and the tube in the lower float portion may be mated at least in part on the interior of the cavity. The tubes may be mated entirely within the interior of the cavity.

The tube in the upper float portion and the tube in the lower float portion may be mated at least in part on the exterior of the cavity.

The tube in the upper float portion may have an outer diameter that is less than the inner diameter of the tube in the lower float portion such that upon mating the upper float portion to the lower float portion the tube in the upper float portion passes through the tube in the lower float portion. The tube of the upper float portion may extend outwardly from the lower float portion. The fishing bobber may further include a sleeve mounted to the tube of the upper float portion on at least a portion of the tube extending outside of the cavity.

The upper float portion and the lower float portion may include mating surfaces for mating the upper float portion to the lower float portion. The mating surfaces may include threaded surfaces configured to be threadably mated. The mating surfaces may include surfaces configured to form an interference or friction fit.

Mating the upper float portion to the lower float portion may results in a joint having characteristics of ultrasonic welding. The fishing bobber may further include an adhesive positioned in the joint formed between the upper float portion and the lower float portion.

The tube in the second portion may extend away from the lower float portion and include at least one line shoulder extending from an outer surface of the tube to within the tube and a movable spring encircling the tube to cover at least a portion of the line shoulder.

The fishing bobber may further include a stem connector attached to the tube, wherein the stem connector includes one or more line shoulders to permit slip bobber fishing and/or fixed bobber fishing.

In another general aspect, a method of fabricating a fishing bobber includes:

providing an upper float portion having an outer surface terminating at one end in a first opening of a first diameter and terminating at a second end in a second opening of a second, larger diameter and having a tube extending from the first opening in the direction of the second opening;

providing a lower float portion having an outer surface terminating at one end in a first opening of a first diameter and terminating at a second end in a second opening of a second, larger diameter and having a tube extending from the first opening in the direction of the second opening; and

mating the second opening of the upper float portion to the second opening of the lower float portion and applying a joining technique that causes the tube of the upper float portion to mate with the tube of the lower float portion to form a channel passing through the combined first and second portions and a joint formed between the upper float portion and the lower float portion and between the tubes results in a cavity.

Embodiments of the method may include one or more of the following features or those described above. For example, the joining technique may include ultrasonic welding. The joining may include application of an adhesive. The joining technique may form a water-tight cavity.

### BRIEF DESCRIPTION OF THE DRAWINGS

FIG. 1 is front view of a slip bobber through which a fishing line has been passed.

FIG. 2 is a front view of the slip bobber of FIG. 1 showing hidden lines.

FIG. 3 is a perspective view of the fishing bobber of FIG. 1 in which the two halves of the bobber is shown separated.

FIG. 4 is a perspective view of the two halves of the fishing bobber of FIG. 3 showing hidden lines.

FIG. 5 is a cross-sectional side view of the fishing bobber of FIG. 1 showing the two halves of the bobber separated.

FIG. 6 is an enlarged cross-sectional side view of the fishing bobber of FIG. 5 showing the connection formed by the two halves of the bobber and the central channel.

FIG. 7 is a cross-sectional side view of an alternative implementation of the fishing bobber of FIG. 1.

FIG. 8 is a cross-section side view of the fishing bobber of FIG. 7 showing the connection between the central channel and the second half of the bobber.

FIG. 9 is a cross-sectional front view of the two halves of an alternative embodiment of the fishing bobber of FIG. 1.

FIG. 10 is an enlarged cross-sectional side view of the fishing bobber of FIG. 9 illustrating the connection between the central channel and the second half of the bobber.

FIG. 11 is an enlarged cross-sectional side view of the fishing bobber of FIG. 9 illustrating the joined halves and the joint line.

FIG. 12 is a front view showing hidden lines of another embodiment of the bobber configured for slip bobber fishing and fixed bobber fishing.

FIG. 12A is a front view showing an embodiment of the bobber configuration having a stem with line shoulders and a spring or sleeve for slip bobber fishing and fixed bobber fishing

FIG. 13 is an enlarged cross-sectional side view showing the joint between the two halves of the bobber of FIG. 12.

FIG. 14 is a front view of another embodiment of the bobber configured with a spring-controlled, slidable central stem.

FIG. 15 is a cross-sectional front view of the two halves of the bobber of FIG. 14 being separated.

FIG. 16 is a cross-sectional front view of an alternative implementation of the bobber.

FIG. 17 is a perspective side view of the two halves of the bobber of FIG. 16.

FIG. 18 is a front view of one halve of an alternative implementation of the bobber.

FIG. 19 is a perspective front view of the two halves of the bobber of FIG. 18.

### DESCRIPTION OF THE PREFERRED EMBODIMENTS

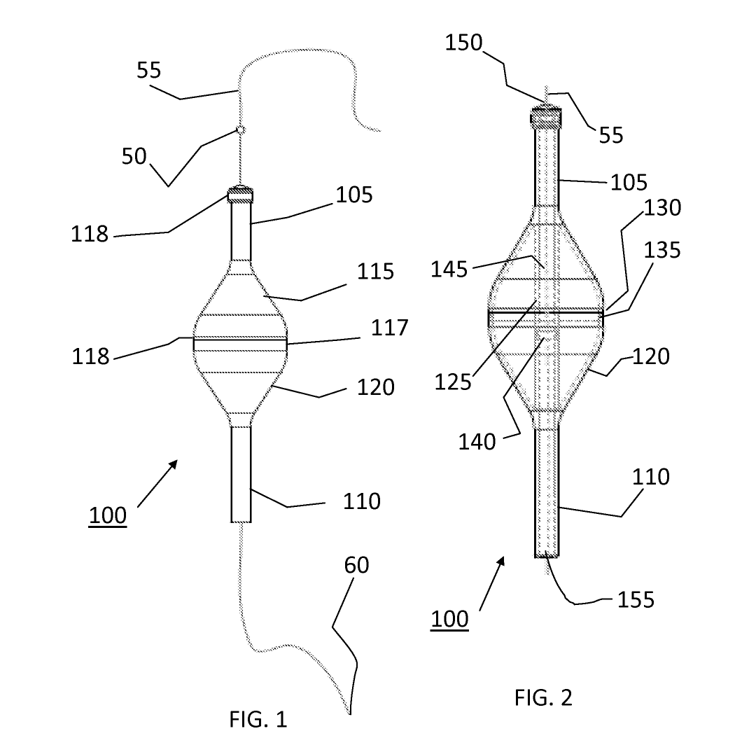

FIG. 1 is perspective front view of a slip fishing bobber 100 in which a fishing line 55 passes from an upper stem 105 of the bobber, through the bobber, and exits the bobber from a lower stem 110 of the bobber. A line stop 50, such as a knot or a combination of a knot and a bead, is attached to the line in a manner known in the art. A fishing hook or other article of fishing tackle is attached to the free end 60 of the line. An additional article fishing tackle, such as a weight, also may be attached to the line adjacent the free end of the line.

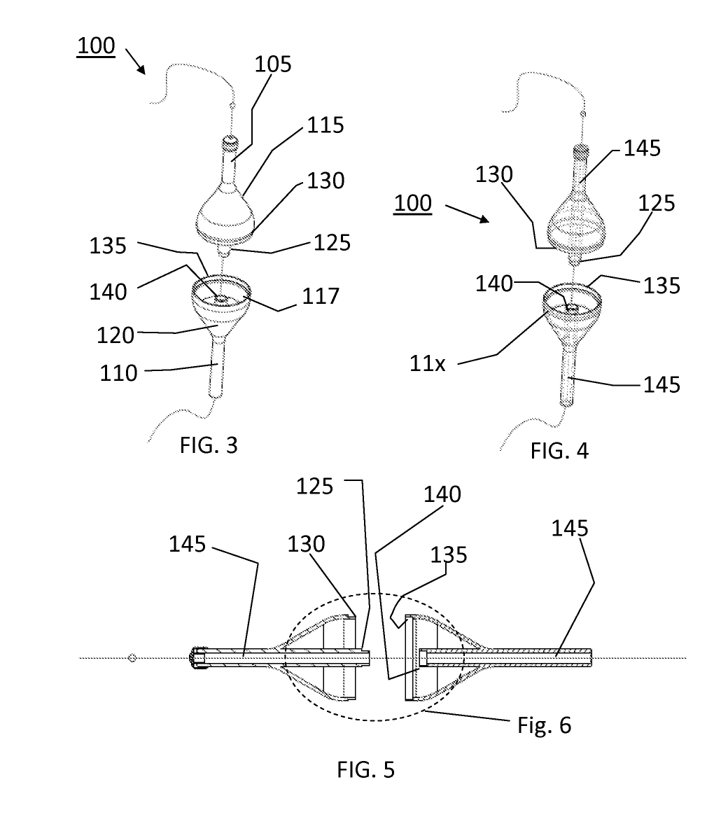

As also illustrated in FIGS. 2-6, the bobber 100 is made from an upper half 115 and a lower half 120. The upper half 115 includes the stem 105, an upper tubular member 125 and an edge surface 130. The edge surface 130 is configured to mate with an edge surface 135 of the lower half 120. The lower half 120 includes the stem 110 and a lower tubular member 140. When the edge surface 130 is mated with the edge surface 135, as illustrated in FIG. 2, the upper tubular member 125 is mated with the lower tubular member 140 to form a tubular member through the bobber having a channel 145 that passes the entire length of the bobber from an upper opening 150 to a lower opening 155. The upper opening 150 is of a diameter such that the line stop 55 will not enter the opening. In this manner, bobber 100 and line 50 are configured for slip bobber fishing. The upper opening 150 may be configured to be an opening formed in the fabrication of the upper half 115 or may be a separate piece, such as a metal or plastic grommet 118, that is positioned at the top of the stem 105 such the grommet has an opening into the channel 145.

The edge surfaces 130, 135 are configured in a manner that permits joining of the upper half 115 to the lower half 120. For example, the edge surfaces can be joined by sonic welding, adhesive, threads, interference fit, thermal adherence, etc., or any combination of these. The resulting joint should be strong and may be imperceptible upon cursory observation of the bobber.

The upper tubular member 125 and the lower tubular member 140 have mating surfaces that permit alignment of the channels through the respective tubular member such that upon joining, the channel 145 is formed with little obstruction from at least the stem 105. It should be understood that in use the fishing line 55 will almost always be passed through the bobber from the stem 105 to the stem 110 rather than the reverse. As such, the channel 145 will be configured to ensure easy passage of a fishing line from the upper stem 105 to the lower stem 110.

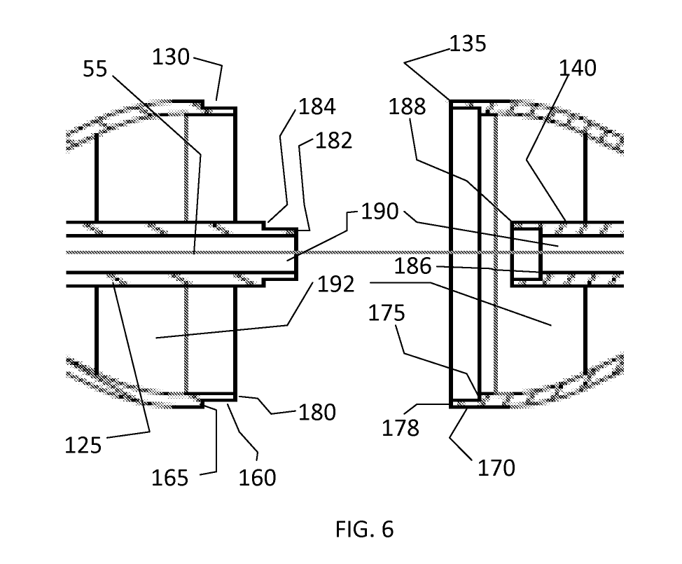

Referring in particular to FIGS. 5 and 6, one possible configuration of the tubular members 125, 140 and the edge surfaces 130, 135 is illustrated. It should be understood that these configurations are exemplary and other configurations are expected to work equally as well or better. The edge surface 130 includes an inner lip 160 and an outer circumferential surface 165. The edge surface 135 includes an outer lip 170 and an inner circumferential surface 175. Upon mating the edge surface 130 to the edge surface 135, the inner lip 170 is positioned against the inner lip 160 and is limited in a joining movement by the circumferential surface 165 contacting a leading edge 178 of edge surface 135. Similarly, a leading edge 180 of the lip 160 is limited in a joining movement by the circumferential surface 175. The joint thereby formed can by ultrasonically welded to form a tight joint. Alternatively, any other suitable joining or adhering means can be used to seal the joint.

A similar joint can be formed from the upper tubular member 125 and the lower tubular member 140 when the two halves 115, 120 are joined. The joint illustrated in FIGS. 5 and 6, however, shows the upper tubular member 125 as including an inner lip 182 and a circumferential surface 184. Upon mating the tubular members 125, 140, the inner surface 186 of the wall of the tubular member 140 surrounds the inner lip 182 and the leading edge 188 of the tubular member 140 is limited in a joining movement by the circumferential surface 184. Upon joining the tubular members, the channel 145 has a segment 190 in which the inner diameter of the channel optionally may gradually narrow down such that a fishing line 55 passed through the bobber from the opening 150 to the opening 155 will not encounter an obstruction to easy movement through the channel 145.

Although FIGS. 5 and 6 illustrate the inner diameter of the channel being constant through the upper tubular member 125, the upper tubular member may be configured as a straight tube of constant inner and outer diameter with the lower tubular member 140 instead being flared outwardly to receive the upper tubular member. Again, in this configuration a fishing line passed from the opening 150 in the direction of the opening 155 will not encounter an obstruction to easy movement through the channel 145.

The tubular members 125, 140 may be joined to have a water tight seal by a variety of adhering and joining means. For example, the tubular members may be joined by sonic welding, adhesive, threads, interference fit, thermal adherence, etc., or any combination of these. A water tight seal should be formed to prevent ingress of water into a cavity 192 formed within the bobber, which could otherwise adversely impact the buoyancy of the bobber.

Referring again to FIG. 1, by using ultrasonic welding to fabricate the bobber 100, or other bobbers as described herein, a variety of different colored plastics can be used to vary the appearance and function of the bobbers. For example, the stem 105 may be a separately extruded or molded tube that is of a different color plastic than the lower portion of the bobber half 115. By preparing the edge of the upper member that is to be joined with the bobber half 115, the upper member can be sonically welded to the bobber half 115 when the bobber half 115 is joined with the bobber half 120. Anglers may find advantages in using an upper member 105 of a different color than the rest of the bobber half 115. It should be understood that either all or a portion of the stem 105 may be separately fabricated and joined to the bobber half 115. For example, a majority of the stem can be molded as part of the bobber half 115 and an approximately 1 cm tubular member may be fit onto the stem and then permanently joined using ultrasonic welding.

As another modification to the stem, the tubular member does not necessarily need to be a hollow tube but can instead have a closed end such that a fishing line cannot be passed through the bobber and thereby cause the fishing bobber to be a stick bobber for fixed bobber fish, e.g., by placement of a fixed bobber system to a bottom stem of the fishing bobber using a spring and a line shoulder positioned within the stem. In this manner, multiple tubular members can be used that vary in one or more of color and presence or absence of an open end. This arrangement reduces manufacturing cost because one die can be used to make the upper float portion for both slip and stick bobbers with the end portion being made using one or more smaller dies.

In another modification possible using, for example ultrasonic welding, the bobber halves 115 and 120 can be separated by a separate ring of plastic 117 that is of a different color than the two halves 115, 120. This ring 117 can be attached using sonic welding to be integral, flush with, and solidly attached to the two halves. Alternatively, the ring can have an inner diameter that is slightly larger than the outer diameter of the joint around which it is placed such that it fits loosely to the bobber but cannot be easily removed from the bobber. If it fits loosely, there may be a slight gap 118 between the ring 117 and the bobber half 115 or 120. In this manner, the bobber 100 can be arranged to have a lower bobber half 120 of a first color, a ring 117 of a second color, an upper bobber half 115 of a third color and a stem 105 of a fourth color. Many anglers will find this useful when observing a bobber on the water as some colors will be easier to see depending upon the weather conditions, e.g., direct sunlight, cloudiness, darkness, amount of sunlight, etc.

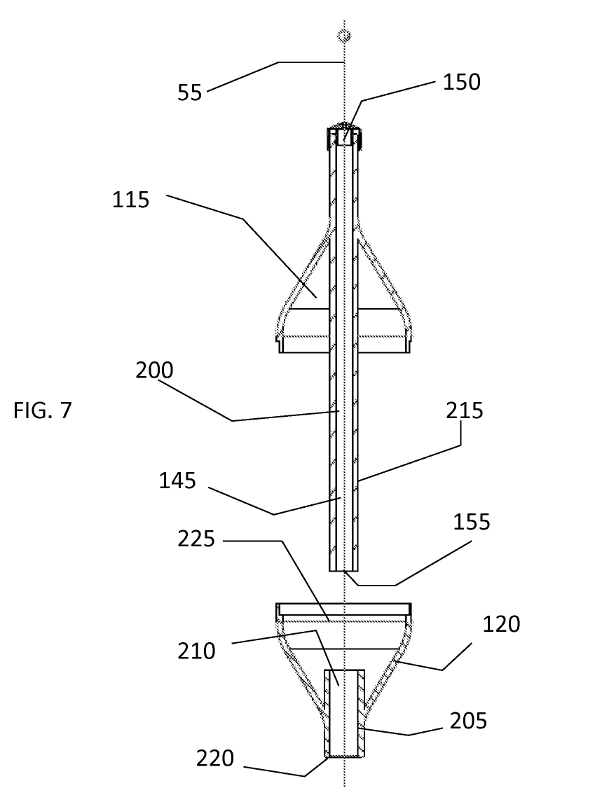

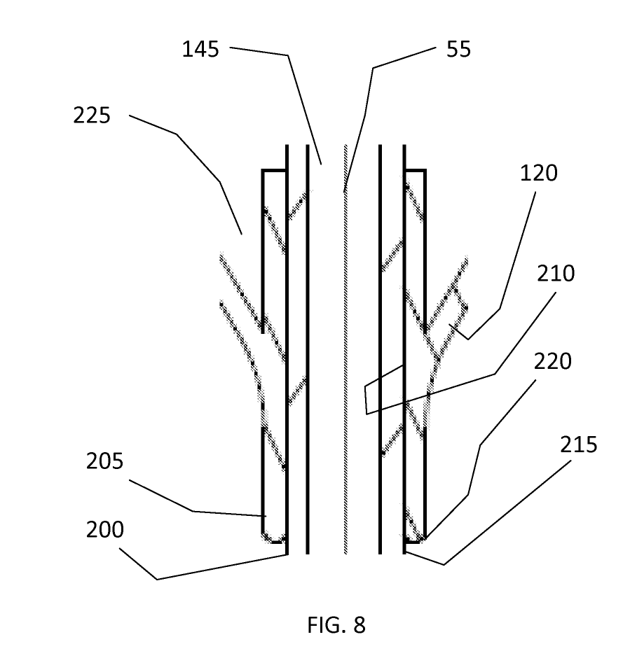

FIGS. 7 and 8 illustrate an alternative embodiment for joining the upper and lower halves 115, 120. An upper tubular member 200 mates with a lower tubular member 205 upon mating the halves 115, 120. As evident in comparing FIG. 7 to FIG. 6, the lengths of the tubular members are changed such that the upper tubular member 200 provides the entire channel 145 in FIG. 7. The lower tubular member 205 is of an inner diameter that permits an interference or friction fit between an inner surface 210 of the lower tubular member 205 and an outer surface 215 of the upper tubular member 200. The lower tubular member 205 also may include a radiused edge 220 that provides a gentle transition from the lower tubular member to the upper tubular member. The tubular members 200, 205 may be joined to have a water tight seal by a variety of adhering and joining means. For example, the tubular members may be joined by sonic welding, adhesive, threads, interference fit, thermal adherence, etc., or any combination of these. A water tight seal should be formed to prevent ingress of water into a cavity 225 formed within the bobber, which could otherwise adversely impact the buoyancy of the bobber.

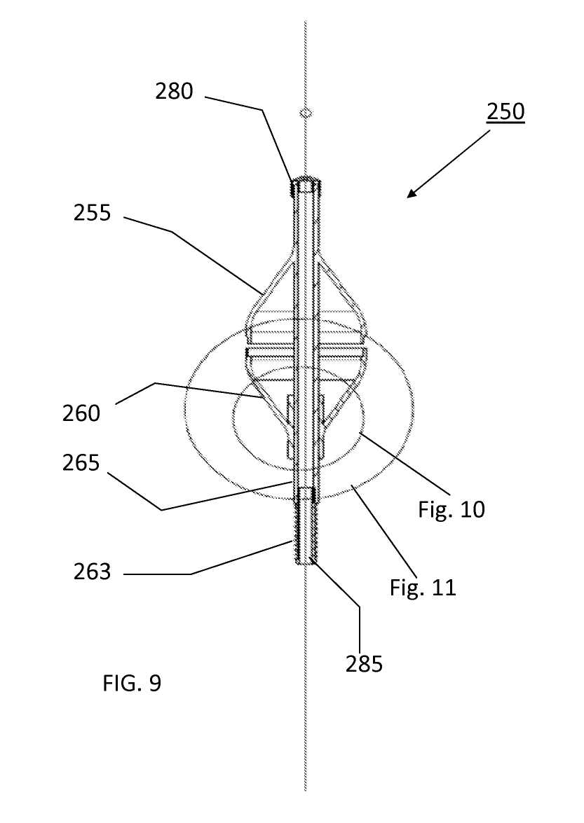

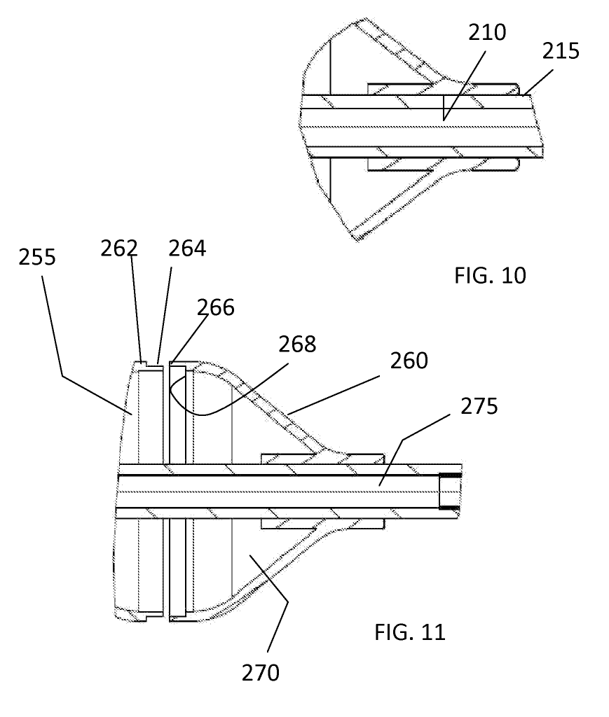

An alternative embodiment of the slip bobber of FIG. 7 is illustrated in FIGS. 9-13 in which a slip bobber 250 is made of an upper half 255, a lower half 260 and a spring or sleeve 263 positioned around the lower stem 265 extending from the upper half. This bobber can be used for both slip bobber fishing or fixed bobber fishing. The bobber can be configured for slip bobber fishing by use of one or more line shoulders molded or cut into the lower stem 265. The stem can be covered by the spring or sleeve 263 that covers the line shoulders partially or completely. Examples of such line shoulders are disclosed in US Publication No. 20090133312, the contents of which are incorporated herein by reference for its teaching of line shoulders for fishing.

The bobber half 255 includes a pair of mating surfaces 262, 264 that are configured to mate with a pair of mating surfaces 266, 268 of the bobber half 260. The mating surfaces can be configured to interlock in the manners described above such that a watertight seal can be formed between the bobber halves 255, 260 such that an air-filled chamber 270 is formed. The joined halves also form a lengthwise channel 275 that passes between an upper opening 280 and a lower opening 285 with the upper opening configured as described above to permit slip bobber fishing. The stem 265 mates with the lower bobber half 260 in a manner similar to that illustrated above in FIGS. 7 and 8 with surfaces 210 and 215 mating to form a water tight seal upon application of a joining technique such as ultrasonic welding or use of an adhesive. Similarly, surfaces 281 and 283 can be configured for easy and reliably joining, such as by application of ultrasonic welding and/or an application of adhesives.

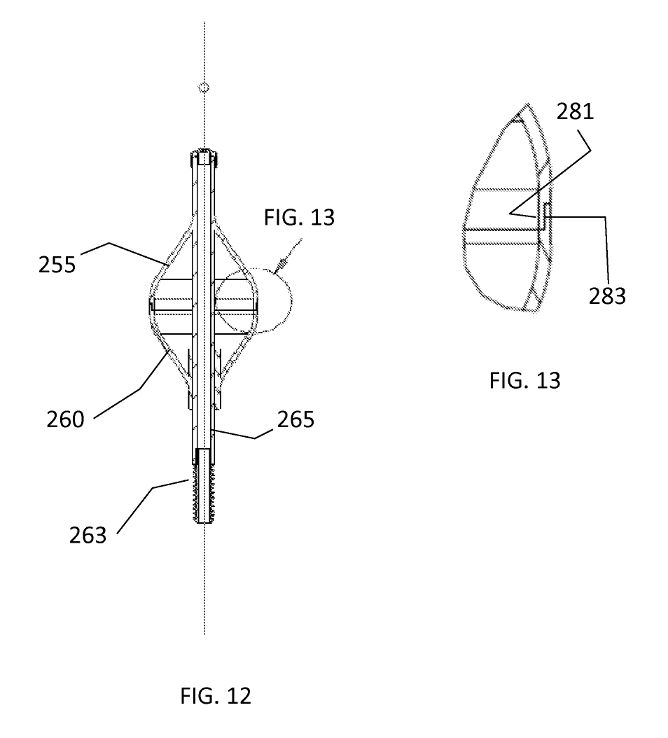

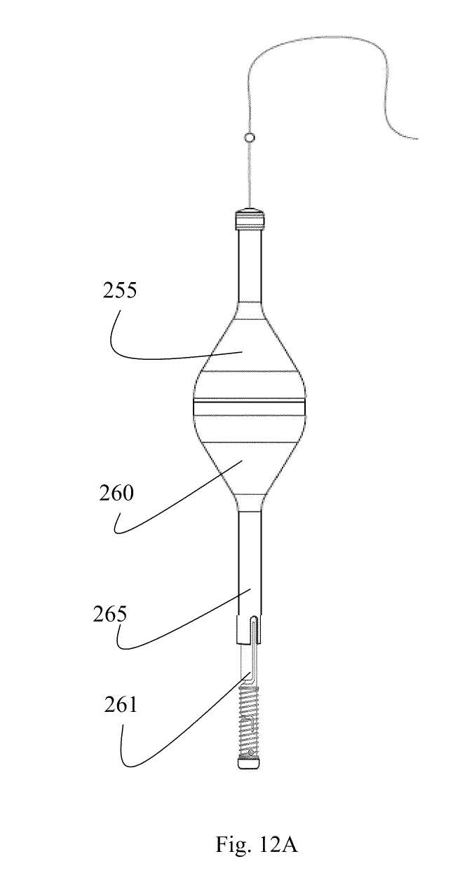

Referring to FIG. 12A, another embodiment of the bobber configuration has a stem 261 with a pair of line shoulders and a spring or sleeve for slip bobber fishing and fixed bobber fishing. The stem 261 has a first line shoulder that extends into the lower stem 265. The edge of the lower stem 265 stops the sleeve or spring from expanding upward to completely cover the first line shoulder. Because the spring covers only a portion of the line shoulder, the fishing line will pass through that portion of the line shoulder that extends into the lower stem 265. An advantage of this configuration is that the line shoulder is expected to remain underwater and permit improved winter slip bobber fishing.

The second line shoulder is positioned at the lower portion of the stem 261 and is configured to be completely covered by the sleeve or spring such that it can be used to fix the fishing line for fixed bobber fishing. It should be understood that in various embodiments, the stem 261 can have either or both of the first and second lines shoulders illustrated in FIG. 12A. Further, the line shoulders described herein may be molded in place, formed by saw cuts and then radiused, etc. In whichever manner they are formed, the line shoulders will have smooth surfaces so as to prevent damage to the fishing line placed within them.

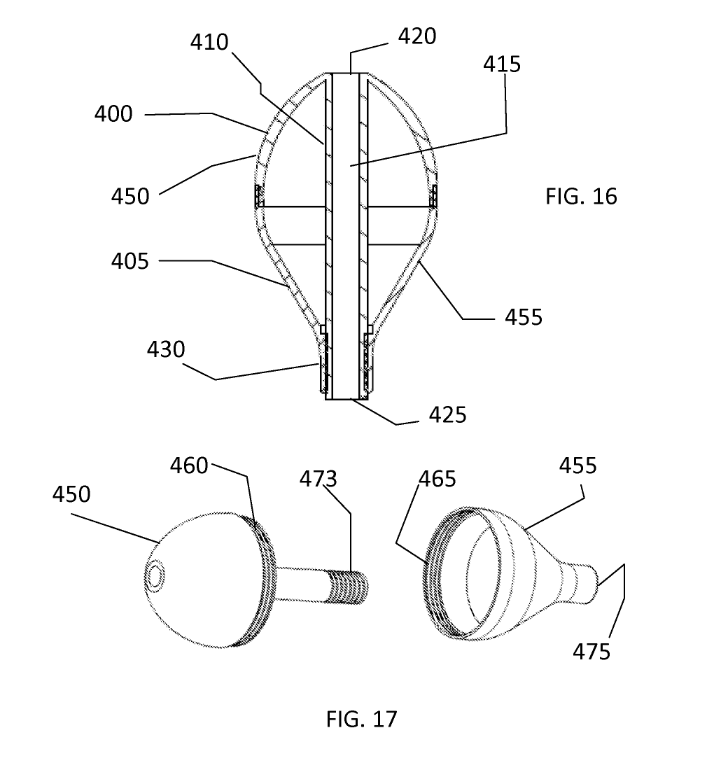

An example of the stem 261 is provided in US Publication No. 20090133312, to Gary Bennis, the contents of which are incorporated by reference in their entirety. In particular, the contents are incorporated by reference for their teaching of a stem 261, its uses, modifications, methods of making, advantages, and ability to be attached to an article of fishing. FIGS. 16-18 of US 20090133312 in particular show one embodiment of one of the stems 261 that can be applied to the bobbers disclosed herein, although the remainder of the stem connectors illustrated in US 20090133312 can also be applied to the bobbers disclosed herein.

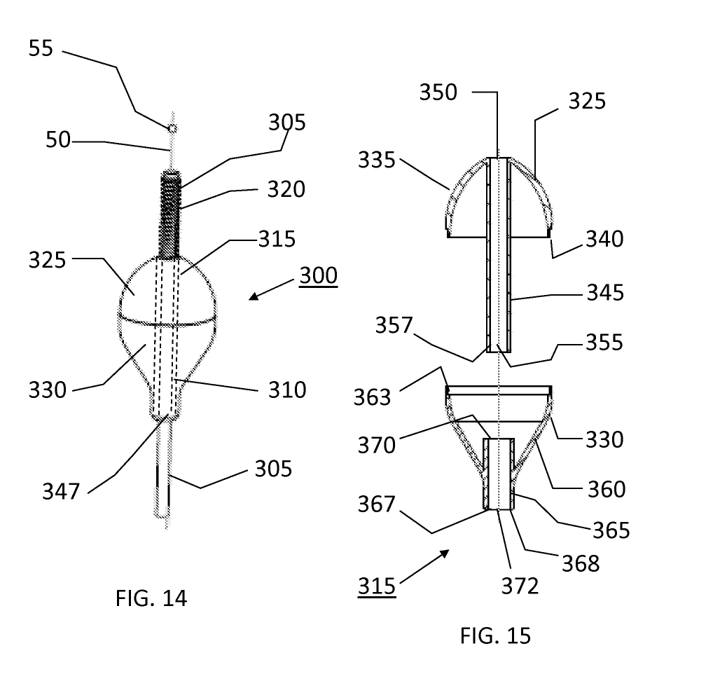

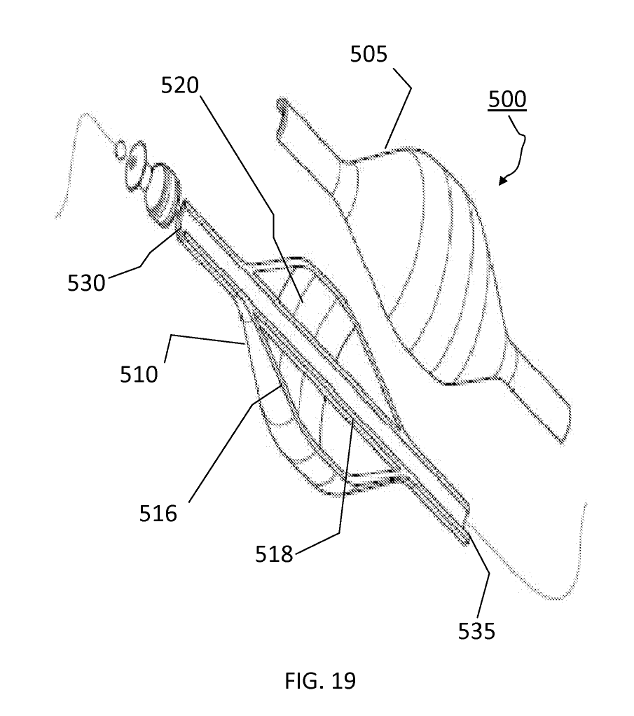

For example, the stem 261 can have an optional hollow channel through its length and can be adhered (e.g., adhesive, welding, thermal attachment, etc.) to the stem 265 such that the channel through its length is collinear with the channel in the stem 265. This configuration will permit slip bobber fishing, for example, in the summer. The stem 261 can be attached within the stem 265, as illustrated in FIG. 12A, or over the stem 265. Similarly, the stem 261 can have a constant outer diameter over its length such that it forms an interference fit within the stem 265. Alternatively, the stem 261 can have a cup at its end that receives the stem 265 within the cup. Such a configuration is illustrated in US 20090133312. FIGS. 19-22 of US 20090133312 illustrate an article of fishing tackle received in the cup end of the stem connector and illustrate how that can be applied to the bobbers described herein. Alternatively, the stem 261 can be formed integrally with the stem 265, e.g., by extrusion, molding, etc. Such an integrally formed stem 261 will have a configuration that is similar to or the same as that illustrated in FIG. 12A. Referring to FIGS. 14 and 15, in another embodiment, a slip fishing bobber 300 is configured to have a slideable rod 305 slidably positioned in a longitudinal cavity 310 of the bobber main body 315 with the slideable rod normally resiliently maintained in the bobber main body in an up position but downwardly displaceable with respect to the bobber main body in response to a first force on the fishing line. The resilience may be supplied, for example, by a spring 320. Such a bobber is disclosed in U.S. Pat. No. 7,437,851 to Bennis, the contents of which are incorporated herein by reference.

The bobber main body 315 includes an upper bobber half 325 and a lower bobber half 330. The upper bobber half 325 includes a spherical surface 335 that includes a mating surface 340 and a tubular member 345. The tubular member 345 defines an inner channel 347 passing between an upper opening 350 and a lower opening 355.

The lower bobber half 330 includes a spherical surface 360 that includes a mating surface 363 and a tubular member 365. The tubular member 365 defines a channel 368 that passes between an opening 370 and an opening 372. The tubular member 345 is of a length and an outer diameter such that upon mating the upper bobber half 325 with the lower bobber half 330, the tubular member 345 forms a friction or interference fit with the inner diameter of the tubular member 365. Upon mating the halves, the end 357 of the tubular member 345 is approximately flush with the end 367 of the tubular member 365. A joint can be formed between the tubular member 345 and the tubular member 365 to form a water tight seal, for example by an adhesive bond or by thermal or ultrasonic welding, etc., or other techniques as known in the art. Similarly to the mating surfaces of the bobber halves 115, 120, the bobber halves 325, 330 may be configured to form a locking, friction or interference fit between the halves to form a water tight seal, for example by an adhesive bond or by thermal or ultrasonic welding, and thereby create a buoyant cavity.

Referring to FIGS. 16 and 17, in a second implementation of the bobber main body 315, an upper bobber half 400 is joined to a lower bobber half 405. The upper bobber half 400 includes an upper tubular member 410 that has a channel 415 passing from an opening 420 to an opening 425. The lower bobber half 405 includes a lower tubular member 430 that has a channel that receives the tubular member 410. The opening 425 may have a radiused end. The bobber halves 400, 405 include spherical halves 450, 455, respectively that have threaded mating surfaces 460, 465 configured to be joined upon mating the bobber halves 400, 405. The joined tubular members 410, 430 define a channel 470 passing the entire length of the bobber main body 315 into which a slidable rod 305 may be inserted. The tubular members have threaded mating surfaces 473, 475 that are joined upon mating of the bobber halves 400, 405.

Rubber or elastic gaskets can be positioned on the tubular members and mating surfaces such that water tight seal are formed upon threadably mating the halves 400, 405. In this manner, the halves 400, 405 can be unscrewed and separated such that different halves can be mated together to provide variety in color, size, shape and function. For example, either of the upper half or the lower half can be configured with a battery and a light emitting diode (LED) or other lighting device such that the bobber can be lighted for night fishing. In such a configuration, either or both of the bobber halves can be clear, translucent or partially translucent to allow for the light to pass through the wall of the bobber.

In another configuration, threadably mating the two bobber halves 400, 405, can be used in a process of permanently sealing the halves and tubular members to make water tight seals by the use of adhesives, sealants, ultrasonic welding, or the like, to the surfaces.

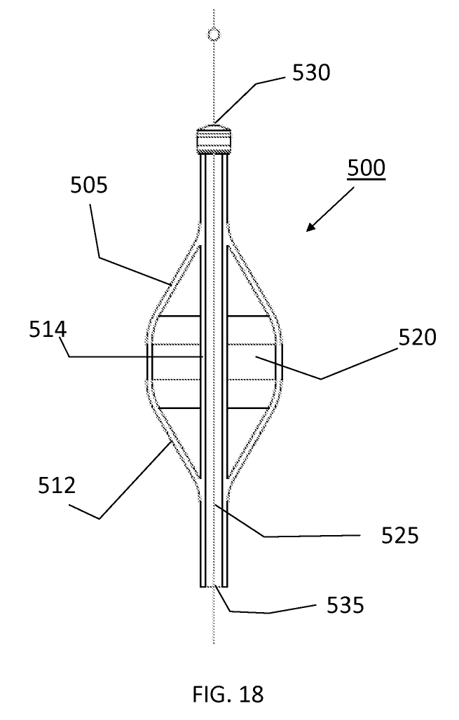

Referring to FIGS. 18 and 19, an alternative embodiment of a slip bobber is illustrated in which a slip bobber 500 is made of two lengthwise halves 505, 510. The bobber half 505 includes a pair of mating surfaces 512, 514 that are configured to mate with a pair of mating surfaces 516, 518 of the bobber half 510. The mating surfaces can be configured to interlock in the manners described above such that a watertight seal can be formed between the bobber halves 505, 510 such that an air-filled chamber 520 is formed. The joined halves also form a lengthwise channel 525 that passes between an upper opening 530 and a lower opening 535 with the upper opening configured as described above to permit slip bobber fishing. The lower end can be configured as described above to include a spring to permit fixed bobber fishing.

It should be understood that references to materials of construction, specific dimensions, and utilities or applications are also not intended to be limiting in any manner and other materials and dimensions could be substituted and remain within the spirit and scope of the invention. Accordingly, it is not intended that the invention be limited, except as by the appended claims.

I claim:

1. A fishing bobber comprising:
an upper float portion comprising an outer surface terminating at one end in a first opening of a first diameter and terminating at a second end in a second opening of a second, larger diameter and having a tube extending from the first opening in the direction of the second opening;
a lower float portion comprising an outer surface terminating at one end in a first opening of a first diameter and terminating at a second end in a second opening of a second, larger diameter and having a tube extending from the first opening in the direction of the second opening;
wherein mating the second opening of the upper float portion to the second opening of the lower float portion causes the tube of the upper float portion to mate with the tube of the lower float portion to form a channel passing through the combined first and second portions and a joint formed between the upper float portion and the lower float portion and between the tubes results in a cavity.

2. The fishing bobber of claim 1, wherein the upper float portion includes a stem extending from the outer surface and terminating in the first opening in a direction that is generally opposite to the direction of the orientation of the tube in the upper float portion.

3. The fishing bobber of claim 2, wherein the stem comprises a tube attached to the upper float portion.

4. The fishing bobber of claim 1, wherein the lower float portion includes a stem extending from the outer surface and terminating in the first opening in a direction that is generally opposite to the direction of the orientation of the tube in the lower float portion.

5. The fishing bobber of claim 1, further comprising a ring positioned between the upper float portion and the lower float portion.

6. The fishing bobber of claim 1, wherein the tube in the upper float portion and the tube in the lower float portion are mated at least in part on the interior of the cavity.

7. The fishing bobber of claim 6, wherein the tubes are mated entirely within the interior of the cavity.

8. The fishing bobber of claim 1, wherein the tube in the upper float portion and the tube in the lower float portion are mated at least in part on the exterior of the cavity.

9. The fishing bobber of claim 1, wherein the tube in the upper float portion has an outer diameter that is less than the inner diameter of the tube in the lower float portion such that upon mating the upper float portion to the lower float portion the tube in the upper float portion passes through the tube in the lower float portion.

10. The fishing bobber of claim 9, wherein the tube of the upper float portion extends outwardly from the lower float portion.

11. The fishing bobber of claim 10, further comprising a sleeve mounted to the tube of the upper float portion on at least a portion of the tube extending outside of the cavity.

12. The fishing bobber of claim 1, wherein the upper float portion and the lower float portion include mating surfaces for mating the upper float portion to the lower float portion.

13. The fishing bobber of claim 12, wherein the mating surfaces comprises threaded surfaces configured to be threadably mated.

14. The fishing bobber of claim 12, wherein the mating surfaces comprises surfaces configured to form an interference or friction fit.

15. The fishing bobber of claim 1, wherein mating the upper float portion to the lower float portion results in a joint having characteristics of ultrasonic welding.

16. The fishing bobber of claim 1, further comprising an adhesive positioned in the joint formed between the upper float portion and the lower float portion.

17. The fishing bobber of claim 1, wherein the tube in the second portion extends away from the lower float portion and includes at least one line shoulder extending from an outer surface of the tube to within the tube and a movable spring encircling the tube to cover at least a portion of the line shoulder.

18. The fishing bobber of claim 1, further comprising a stem connector attached to the tube, wherein the stem connector includes one or more line shoulders to permit slip bobber fishing and/or fixed bobber fishing.

19. A method of fabricating a fishing bobber, the method comprising providing an upper float portion comprising an outer surface terminating at one end in a first opening of a first diameter and terminating at a second end in a second opening of a second, larger diameter and having a tube extending from the first opening in the direction of the second opening;
providing a lower float portion comprising an outer surface terminating at one end in a first opening of a first diameter and terminating at a second end in a second opening of a second, larger diameter and having a tube extending from the first opening in the direction of the second opening; and
mating the second opening of the upper float portion to the second opening of the lower float portion and applying a joining technique that causes the tube of the upper float portion to mate with the tube of the lower float portion to form a channel passing through the combined first and second portions and a joint formed between the upper float portion and the lower float portion and between the tubes results in a cavity.

20. The method of claim 19, wherein the joining technique comprises ultrasonic welding.

21. The method of claim 19, wherein the joining comprises application of an adhesive.

22. The method of claim 19, wherein the joining technique forms a water-tight cavity.
